(19) United States
(12) Patent Application Publication
(10) Pub. No.: US 2012/0143669 A1
(43) Pub. Date: Jun. 7, 2012

(54) LOYALTY OFFER MODELING

(75) Inventors: Anoop Anantha, Kirkland, WA (US); Murali R. Krishnan, Clyde Hill, WA (US); Miller Thomas Abel, Mercer Island, WA (US)

(73) Assignee: MICROSOFT CORPORATION, Redmond, WA (US)

(21) Appl. No.: 12/958,841

(22) Filed: Dec. 2, 2010

(51) Int. Cl. G06Q 30/00

(52) U.S. Cl. 705/14.27

(57) ABSTRACT

Loyalty offer modeling techniques are described. In one or more implementations, interaction with a loyalty service via a network is performed to model one or more loyalty offers for a use in conjunction with a merchant. Information is transmitted via the network for receipt by the loyalty service, at least a portion of the information describing consumer interaction with the merchant that pertains to the loyalty offer that is sufficient for use by the loyalty service to manage participation of the consumers with the one or more loyalty offers of the merchant.

### BACKGROUND

Mobile communication devices such as wireless phones have become a common part in the everyday life of a wide variety of users. Consequently, the mobile communication device may serve as a primary point of contact for a variety of business and personal uses. For example, a business user may utilize the mobile communication device to receive email, a casual user may send text messages to friends, either one of the users may share pictures, and so on.

However, traditional techniques that were employed to securely store data on the mobile communication device as well as to communicate data to the mobile communication device could result in the data being “in the clear.” Even if but for a brief moment in time, malicious parties may take advantage of this vulnerability to steal sensitive data. This may even result in the ability by the malicious party to access other information on the mobile communication device itself. Consequently, functionality of the mobile communication device may be limited from meeting its true potential due to the ability to compromise data on the mobile communication device.

### SUMMARY

Loyalty offer modeling techniques are described. In one or more implementations, interaction with a loyalty service via a network is performed to model one or more loyalty offers for a use in conjunction with a merchant. Information is transmitted via the network for receipt by the loyalty service, at least a portion of the information describing consumer interaction with the merchant that pertains to the loyalty offer that is sufficient for use by the loyalty service to manage participation of the consumers with the one or more loyalty offers of the merchant.

In one or more implementations, information is collected from a plurality of merchants that describes participation in one or more loyalty offers associated with respective merchants. The information includes an identifier of a respective loyalty offer provided by a mobile communication device having telephone functionality to a respective merchant to participate in the offer at a physical location of the merchant. Reports are generated for communication to respective merchants that describes the participation and relative qualification for respective offers of the merchant.

In one or more implementations, a mobile communication device comprises a processor, hardware configured to implement telephone communication, tamper-resistant hardware implementing a secure element as storing purchase credentials usable to initiate a purchase of a good or service; and loyalty offer credentials usable to participate in a loyalty offer of a respective one of a plurality of merchants; and memory having instructions stored therein. The instructions are executable by the processor to cause the mobile communication device to search the loyalty offer credentials stored in the secure element.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example implementation of a mobile communications device in communication with a marketplace in accordance with one or more embodiments of devices, features, and systems for mobile communications.

FIG. 2 is an illustration of a system in an example implementation in which a mobile communication device of FIG. 1 interacts with a merchant to purchase a good or service and participate in a loyalty offer.

FIG. 3 is an illustration of a system in an example implementation in which a loyalty offer is modeled by a merchant for management by a loyalty service of FIG. 2.

FIG. 4 is a flow diagram depicting a procedure in an example implementation in which a loyalty offer is modeled by a merchant for management by a loyalty service.

FIG. 5 is a flow diagram depicting a procedure in an example implementation in which information is collected by a loyalty service to manage participation in loyalty offers for a plurality of merchants.

FIG. 6 illustrates various components of an example device that can be implemented in various embodiments as any type of a mobile device to implement embodiments of devices, features, and systems for mobile communications.

### DETAILED DESCRIPTION

### Overview

Loyalty offers may be used by merchants to promote business with the merchant. For example, a merchant may offer a discount for a purchase of gas for every “X” amount of groceries purchased, offer an 11^{th} cup of coffee free after purchase of ten cups, a discount based on a dollar amount of purchased media, and so on. In this way, a consumer may be incentivized to purchase goods or services from a particular merchant.

However, the consumer may be confronted with a variety of different loyalty offers from a variety of different merchants. Further, the different merchants may employ different techniques to track the consumer's loyalty in relation to qualifying for the offer, such as punch cards, magnetic swipe cards, and so on. Consequently, a user may be confronted with a wide variety of different types of cards that may consume a limited amount of space in the user's wallet. Thus, this may be inefficient and interfere with the user's ability to participate with the loyalty offers.

Loyalty offer techniques are described. In implementations, a mobile communication device (e.g., a mobile phone) is utilized to maintain data related to participation in one or more loyalty offers. For example, the mobile communication device may be configured to maintain an “electronic wallet” that includes credentials to purchase goods or services. The wallet may also be configured to maintain identifiers that may be communicated with the credentials to participate in a loyalty offer. In this way, a user may efficiently interact with merchants to purchase goods or services as well as participate in loyalty offers of the merchant.

Additionally, the loyalty offers may be modeled by a merchant for management by a loyalty service such that the merchant may “outsource” the management of the offers. A merchant having a mobile communication device (e.g., a wireless phone), for instance, may access a loyalty service over the internet. The loyalty service may provide templates and so on such that the merchant may model a desired loyalty offer, such as “get ‘x’ percent off,” “buy ten get one free,” and so on. The loyalty service may then manage this and other loyalty offers from a variety of merchants, thereby providing a service to model and maintain the offers, which may also be monetized by the service through a subscription, pay per use, advertisements, and so on. This management may also be used to provide a wide variety of other functionality, such as reporting both to the merchant and consumer, automatic selection of relevant loyalty offers at a point of sale, and so on, further discussion of which may be found in relation to the following sections.

In the following discussion, a variety of example implementations of a mobile communication device having telephone functionality (e.g., a wireless phone) are described. Additionally, a variety of different functionality that may be employed by the mobile communication device is described for each example, which may be implemented in that example as well as in other described examples. Accordingly, example implementations are illustrated of a few of a variety of contemplated implementations. Further, although a mobile communication device having one or more modules that are configured to provide telephonic functionality are described, a variety of other mobile devices are also contemplated, such as personal digital assistants, mobile music players, dedicated messaging devices, portable game devices, netbooks, and so on.

Example Implementations

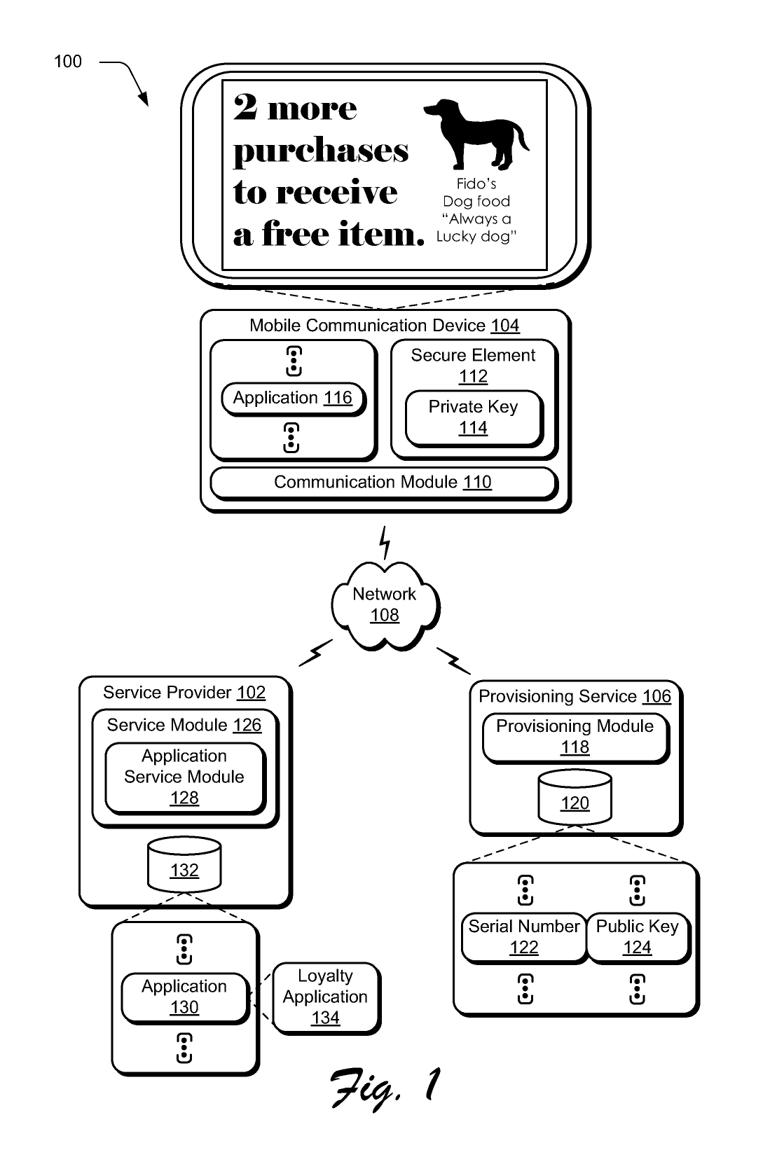

FIG. 1 is an illustration of an example implementation of an environment 100 that is operable to employ the techniques described herein. The environment includes a service provider 102, a mobile communication device 104, and a provisioning service 106 that are illustrated as communicatively coupled, one to another, via a network 108. Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be representative of multiple networks.

The mobile communication device 102 is further illustrated as including a communication module 110. The communication module 110 is representative of functionality of the mobile communication device 102 to communicate via the network 108. For example, the communication module 110 may include telephone functionality to make and receive telephone calls, such as by employing a telephone module to communicate via a plain old telephone service (POTS), wireless network (e.g., cellular and/or Wi-Fi), and so on.

The communication module 110 may also include a variety of other functionality, such as to capture content, form short message service (SMS) text messages, multimedia messaging service (MMS) messages, emails, status updates to be communicated via a social network service or micro-blog, and so on. For instance, the communication module 110 may also support browser functionality to browse the network 108.

The mobile communication device 104 is further illustrated as including a secure element 112. In one or more implementations, the secure element 112 is representative of functionality to support secure communications with the mobile communication device 104. The secure element 112 may be implemented using hardware and configured during manufacture to include a private key 114 and a variety of other keys. For instance, the secure element 112 may be implemented using a tamper-resistant integrated circuit that is resistant to “snooping” as well as physical removal from the mobile communication device 104 by a manufacturer of the device. For example, the manufacturer may cover a surface-mounted integrated circuit with an epoxy that helps to prevent snooping of the circuit as well as causing the circuit to break if removal is attempted.

In implementations, the secure element 112 includes functionality to perform encryption and/or decryption operations. For example, the secure element 112 may use the private key 114 to perform a decryption operation and expose a result of the operation to other functionality of the mobile communication device 104, such as to one or more applications 116 that are executable by the mobile communication device 104. In this example, the secure element 112 may receive data to be decrypted from the application 116, decrypt the data using the private key 114, and then expose a result of the decryption operation (i.e., the decrypted data) to the application 116. Therefore, inclusion of the private key 114 in the secure element 112 may help to protect the private key 114 from discovery “outside” the secure element 112 by keeping the private key 114 from being exposed “in the clear” during the decryption operation.

A variety of other functionality may also be supported through use of the secure element 112. For example, the secure element 112 may support a protected communication channel through the provisioning service 106. The provisioning service 106, for instance, may include a provisioning module 118 and storage 120. The storage 120 may be used to maintain a serial number 122 assigned to an integrated circuit that includes the secure element 112 and a corresponding public key 124 that forms an asymmetric public/private key pair with the private key 114 of the mobile communication device 104. The provisioning module 118 may thus provide the public key 124 to third-party services such that communication between the third-party service and the mobile communication device 104 is protected, even if that communication occurs using the provisioning service 106 or other service as an intermediary.

For example, a user of the mobile communication device 104 may interact with the communication module 110 or other functionality (e.g., an application 116) to navigate to a service provider 102 over the network 108. The service provider 102 as illustrated includes a service module 126 that is representative of functionality to provide one or more services for access via the network 108.

An example of one of these services is illustrated as implemented by an application service module 128. The application service module 128 is representative of functionality to manage dissemination of one or more applications 130 via the network 108. Although the applications 130 are illustrated as stored in storage 132 local to the service provider 102 (e.g., as part of a server farm that implements the service provider 102), the storage 132 may be representative of a wide variety of different types of storage, e.g., third-party storage.

In an example, the application service module 138 manages a marketplace configured to provide applications 130 for purchase via the network 108. Therefore, a user of the mobile communication device 104 may access the marketplace to purchase one or more of the applications 130 for download to local storage, which is illustrated as application 116 in this example. To purchase and/or transport the application 130, the mobile communication device 104 and the service provider 102 may utilize secure communications implemented at least in part through use of the secure element 112. The secure communications may be implemented in a variety of ways.

In one instance, the public key 124 is provided to secure communications between the service provider 102 and the mobile communication device 104 directly. For example, the public key 124 may be located by the provisioning module 118 of the provisioning service 106 by obtaining a serial number 122 for the integrated circuit that implements the secure element 112, e.g., from the mobile communication device 104. The provisioning module 118 may then use the serial number 122 to locate the public key 124 and provide the public key 124 to the service provider 102. The public key 124 may then be used to encrypt data to be communicated to the mobile communication device 104, such as the application 130, billing information and other credentials, and so on.

In another instance, the provisioning service 106 provides the public key 124 to the service provider 102 as a basis to support indirect communications, such as to securely transport credentials and other data (e.g., cryptographic keys) that are to be used as a basis to form a communication channel. For example, the service provider 102 may provide credentials (e.g., other cryptographic keys) that are to be used to secure communications between the service provider 102 and the mobile communication device 104. To protect these credentials from compromise by malicious parties, the credentials may be encoded using this public key 124. In other words, the other cryptographic keys may be encrypted using the public key 124 for communication to the mobile communication device 104 to protect the other cryptographic keys from discovery by malicious parties.

In this way, regardless of whether the communication is communicated indirectly via the provisioning service 106 or directly via the network 108, the credentials (e.g., the other cryptographic keys) are protected from discovery through encryption using the public key 124. Therefore, even the provisioning service 106 itself is not able to determine “what” is being communicated between the service provider 102 and the mobile communication device 104.

The mobile communication device 104 may then decrypt the communication using the secure element 112, and more particularly the private key 114, to obtain the other cryptographic keys. A variety of different techniques may then be employed to utilize the other cryptographic keys once decrypted.

In one technique, the other cryptographic keys are exposed for use outside the secure element 112, such as by an application 116 or other functionality of the mobile communication device 104. Thus, in this techniques the secure element 112 is leveraged to provide the credentials that are used to serve as a basis to secure communications but is not used to secure the communications itself, i.e., to provide the actual encryption/decryption.

In another technique, the other cryptographic keys may be kept from being exposed outside the secure element 112 through storage within the secure element 112. The secure element 112 may then use the cryptographic keys as previously described to decrypt and/or encrypt data received by the secure element 112 without exposing the cryptographic keys “outside” the secure element 112. The secure element 112 may thus employ a variety of different techniques to secure communications with the mobile communication device 104, the example of the service provider 102 above being but one of many such examples.

The secure element 112 may be leveraged to provide a variety of different functionality. For example, a user of the mobile communication device 104 may navigate to the service provider 102 to obtain a loyalty application 134. The loyalty application 134 may be provided by a merchant to promote business with a merchant, such as to implement a loyalty offer (e.g., a rewards program) and other functionality that may be beneficial to the user.

The loyalty application 134 may then be communicated to the mobile communication device 104 and provisioned using the techniques previously described in conjunction with the provisioning service 106. For instance, an identifier may be communicated and stored at the mobile communication device 104 using the secure communication techniques described above, e.g., within the secure element 112 or elsewhere in memory. In this way, the mobile communication device 104 may be configured to maintain data that may be used in conjunction with a loyalty offer on the mobile communication device 104. Further, the loyalty application may be used to track participation with one or more offers, an example of which is illustrated as output via a user interface on the mobile communication device 104. A variety of other examples are also contemplated, further discussion of which may be found in relation to the following figure.

Generally, any of the functions described herein can be implemented using software, firmware, hardware (e.g., fixed logic circuitry), or a combination of these implementations. The terms “module” and “functionality” as used herein generally represent hardware, software, firmware, or a combination thereof In the case of a software implementation, the module, functionality, or logic represents instructions and hardware that performs operations specified by the hardware, e.g., one or more processors and/or functional blocks.

The instructions can be stored in one or more computer-readable media. As described above, one such configuration of a computer-readable medium is signal bearing medium and thus is configured to transmit the instructions (e.g., as a carrier wave) to the hardware of the computing device, such as via the network 104. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data. The features of the techniques described below are platform-independent, meaning that the techniques may be implemented on a variety of commercial computing platforms having a variety of hardware configurations.

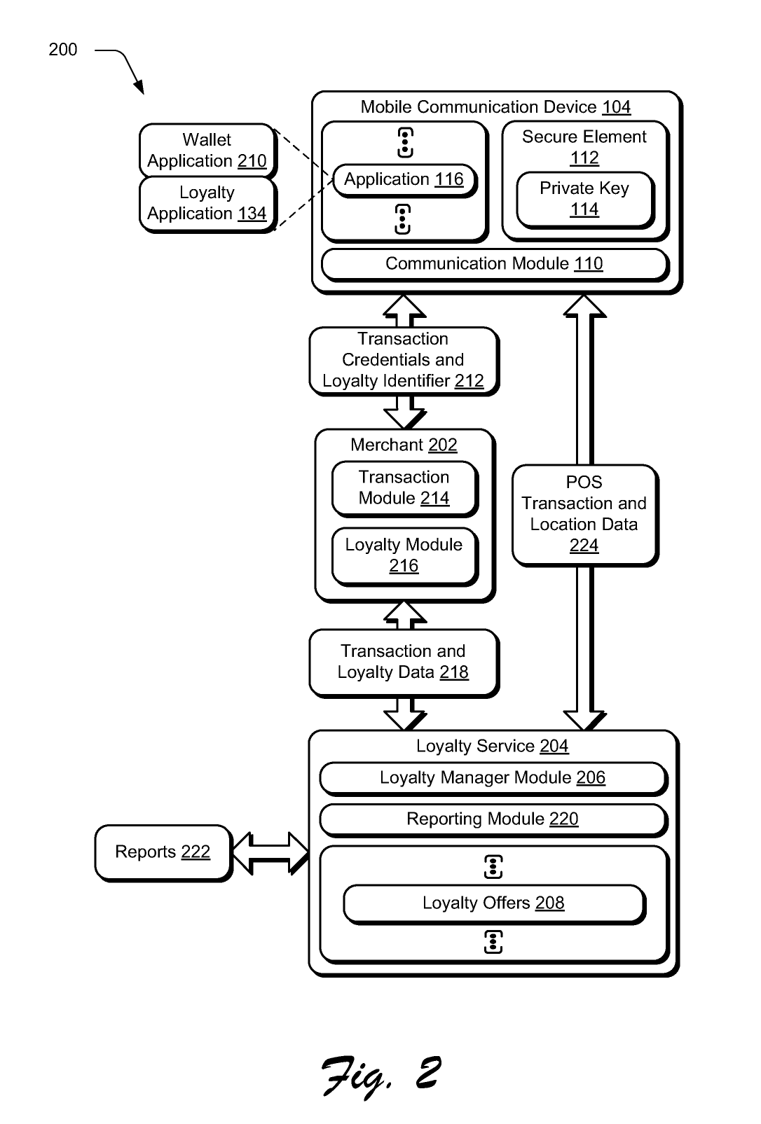

FIG. 2 depicts a system 200 in an example implementation in which a mobile communication device 104 interacts with a merchant to purchase a good or service and participate in a loyalty offer. The system 200 as illustrated includes the mobile communication device 104 as well as a merchant 202 and a loyalty service 204.

The loyalty service 204 may be implemented in a variety of ways, such as a stand-alone service, part of the provisioning service 106, and so on. The loyalty service 204 is further illustrated as including a loyalty manager module 206 that is representative of functionality to maintain one or more loyalty offers 208. Loyalty offers 208 may be configured in a variety of ways. For example, the loyalty offer 208 may specify a unit of loyalty, such as a number of purchases, a dollar amount, purchase frequency, and so on.

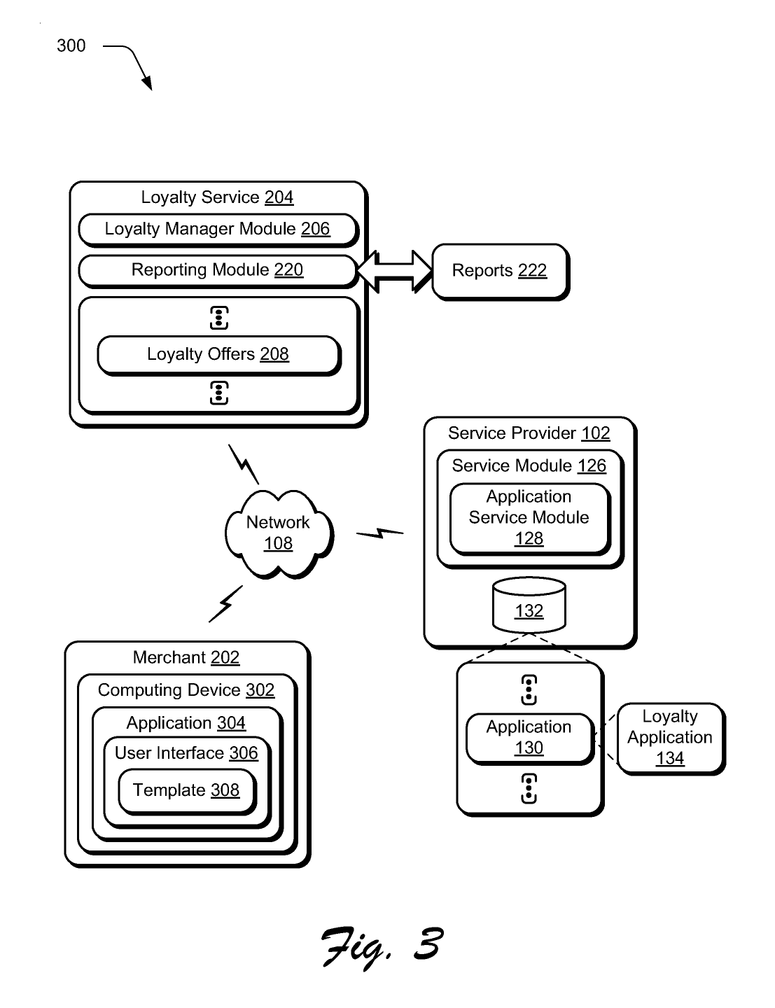

The loyalty offer 208 may also specify a threshold for an action relating to loyalty, such as five purchases to receive a ten percent discount. These offers may be generated in a variety of ways, such as based on data received from the merchant 202, through entry in a user interface that is exposed via a network, and so on, further discussion of which may be found in relation to FIG. 3. The loyalty service 204 may then be used to manage the loyalty offer 208, an example of which follows.

As previously described, the mobile communication device 104 may execute a variety of different applications 116, such as the loyalty application 134 previously described, a wallet application 210, and so on. The wallet application 210, for instance, may be configured to operate in conjunction with the secure element 112 to provide credentials to the merchant to purchase a good or service. Likewise, the loyalty application 134 may be configured to provide an identifier that may be used to track participation of a user of the mobile communication device 104 with the loyalty offer 208.

The identifier may be configured in a variety of ways, such as a unique identifier assigned by the loyalty service 204 (e.g., that matches a number on a plastic magnetic swipe card), a unique identifier of the mobile communication device 104 itself, and so on. Additionally, the loyalty identifier may be stored in a variety of locations, such as in general memory of the mobile communication device 104, within the secure element 112, and so on. In this way, the mobile communication device 104 may serve as an “electronic wallet” to maintain identifiers related to loyalty offers as well as to facilitate purchases.

For instance, the mobile communication device 104 may be carried by a user of the mobile communication device 104 to a physical location of the merchant 202, such as a traditional “bricks and mortar” store. The mobile communication device 104 may then be used to communicate transaction credentials (e.g., credit card information, a user login and password, and so on) and a loyalty identifier 212 to the merchant 202 to initiate the transaction. The transaction credentials and loyalty identifier 212 may be communicated in a variety of ways, such as by using near field technology (NFT) to communicate wirelessly over a short distance, via a Wi-Fi network, via a cellular network, and so on.

The merchant 202 may then continue processing the transaction credentials and the loyalty identifier 212 to complete the purchase as well as to process participation with the loyalty offers 208. For example, the merchant 202 may employ a transaction module 214 that is representative of functionality to complete a purchase of a good or service. Likewise, the merchant 202 may employ a loyalty module 216 to process data describing participation of the mobile communication device 104 with one or more loyalty offers. Thus, in this example the merchant 202 may perform processing for the transaction and/or the loyalty service.

The merchant 202 may also employ the loyalty service 204 to perform this processing. For example, the merchant 202 may communicate transaction and loyalty data 218 to the loyalty service 204 over a network. The loyalty service 204 may then employ a loyalty manager module 206 to manage participation with the loyalty offer 208. Likewise, the loyalty service 204 may also include a reporting module 220 that may be configured to generate financial and other reports 222 describing the transactions (e.g., for processing by another service), participation in the loyalty offers 208, and so on. Further, these techniques may be provided to a plurality of different merchants for a plurality of different loyalty offers. Thus, the loyalty service 204 in this example may act as a centralized point (e.g., a clearinghouse) to manage loyalty offers 208 of merchants 202. Such a service may be provided to the merchants for a fee.

Further, although communication through the merchant 202 with the loyalty service 204 was described, direct communication between the mobile communication device 104 and the loyalty service 204 may also be supported. For example, the mobile communication device 104 may communicate point of sale (POS) transaction and location data 224 to the loyalty service 204. This data may then be used to manage participate with the loyalty offers 208. Further, this data may also be used to model user preferences of the mobile communication device 104. For example, the loyalty manager module 206 may include functionality to model which offers were utilized by the mobile communication device 104.

Yet further, this modeling may even serve to track other user behavior in relation to the loyalty offers 208. For example, the loyalty manager module 206 may track other purchases made by the mobile communication device 104, even if the purchases do not correspond to one or more of the loyalty offers. In this way, the loyalty service 204 may determine that the loyalty offers 208 were successful at getting prospective customers “through the door” to purchase goods and services even if those goods and services were not involved with the offer. Other functionality is also contemplated, such as to “push” advertisements to the mobile communication device 104, e.g., advertisements based on the user profile.

FIG. 3 illustrates a system 300 in an example implementation in which a loyalty offer is modeled by a merchant for management by the loyalty service 204 of FIG. 2. The system 300 includes the service provider 102 of FIG. 1 and thus includes a service module 126 having an application service module 128 that is configured to provide an application marketplace to make applications 130 available for download via the network 108 from storage 132.

The system also includes the merchant 202 and the loyalty service 204 from FIG. 2. The loyalty service is illustrated as including a reporting module 220 that may be configured to generate reports 222 that describe a variety of transactions that may involve the loyalty offer 208 and/or transactions performed at the merchant 202. The loyalty service 204 is also illustrated as including a loyalty manager module 206 configured to manage loyalty offers 208 for a plurality of different merchants, an example of one such merchant is illustrated as merchant 202. The loyalty offers 208 may be provided to the loyalty service 204 for management in a variety of ways.

A user of a computing device 302 (e.g., a mobile communication device 104, desktop PC, and so on) of the merchant 202, for instance, may download an application 304 from the application marketplace of the service provider 102, from the loyalty service 204, or elsewhere. Other examples are also contemplated, such as configuration of the application 304 as a browser to interact with the loyalty service 204 via the network 108.

In either instance, the application 304 may provide a user interface 306 via which the user of the computing device 302 may model a loyalty offer 208. The user interface 306, for instance, may employ one or more templates 308 via which the user may specify properties for a desired loyalty offer, e.g., supply values of “x” and “y” in a “buy ‘x’ get ‘y’ free” template. The loyalty offer 208 may also include one or more coupons to encourage a prospective consumer to visit a physical location of the merchant 202, visit a website of the merchant 202, and so on. This information may then be communicated from the merchant 202 to the loyalty service for management by the loyalty manager module 206.

This information may be managed by the loyalty service 204 in a variety of ways. The loyalty service 204, for instance, may receive data from the merchant 202 to manage participation by consumers with the loyalty offers 208 as described in relation to FIG. 2. For example, the loyalty service 204 may provision credentials to mobile communication devices of consumers such that the consumers may automatically participate in the loyalty offers 208 when making purchases from the merchant 202.

The loyalty service 204 may also configure the loyalty offers 208 modeled by the merchant 202 for inclusion in a loyalty application 134 that is to be made available via the application marketplace of the service provider 102. For example, the loyalty application 134 may be configured specifically for the merchant 202, such as employing branding and the loyalty offers 208 of the merchant 202. Thus, a prospective consumer that may be interested in loyalty offers of the particular merchant 202 may obtain the loyalty application 134 from the application marketplace of the service provider 102 to employ these offers.

In another example, the loyalty application 134 may be utilized to participate in loyalty offers 208 for a plurality of different merchants 202 that are managed by the loyalty service 204. A user of the mobile communication device 104 of FIG. 2, for instance, may download the loyalty application from the application marketplace of the service provider 102 or elsewhere. The loyalty application 134 may be configured to provide credentials automatically and without user intervention to the merchant 202 to participate in the loyalty offers 208. The mobile communication device 104, for instance, may communicate loyalty identifiers or other credentials along with billing credentials that are usable to purchase a good or service from the merchant 202.

The loyalty application 134 may also provide search functionality to identify particular loyalty offers 208 that may be of interest to a user of the mobile communication device 104. The loyalty application 134, for instance, may output a user interface that provides loyalty offers 208 that are relevant within a current geographic area of the mobile communication device 104, e.g., using GPS functionality. Thus, the loyalty application 134 may perform this search automatically and without user intervention to output loyalty offers 208 of interest. A variety of other search functionality is also contemplated, such as to permit a user to locate categories of loyalty offers 208 of interest (e.g., restaurants, supermarkets, etc.), based on identification of a particular merchant (e.g., location at a physical premises of the merchant and/or business transaction with the merchant), and so forth. Further discussion of these and other techniques may be found in relation to the following procedures.

Example Procedures

The following discussion describes loyalty offer modeling techniques that may be implemented utilizing the previously described systems and devices. Aspects of each of the procedures may be implemented in hardware, firmware, software, or a combination thereof The procedures are shown as a set of blocks that specify operations performed by one or more devices and are not necessarily limited to the orders shown for performing the operations by the respective blocks. In portions of the following discussion, reference will be made to the environment 100 and systems 200 and 300 of FIGS. 1-3, respectively.

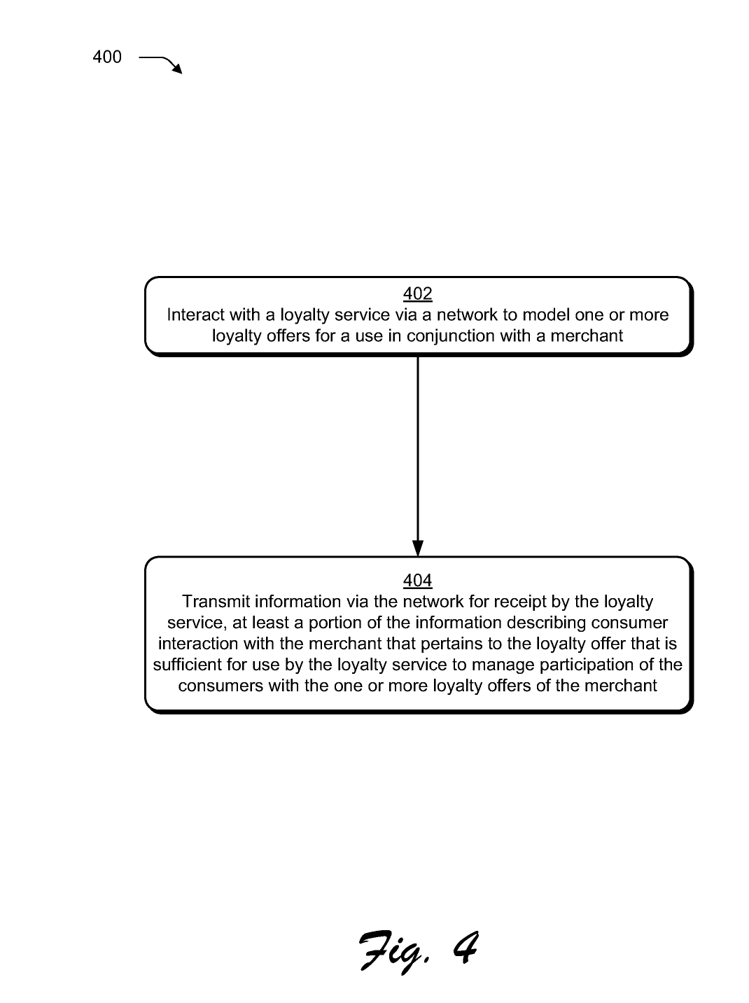

FIG. 4 depicts a procedure 400 in an example implementation in which a loyalty offer is modeled by a merchant for management by a loyalty service. Interaction with a loyalty service is performed via a network to model one or more loyalty offers for use in conjunction with a merchant (block 402). A user may interact with the computing device 302, for instance, and output a user interface to specify properties for a loyalty offer. The computing device may be configured in a variety of ways, such as a traditional personal computer or a mobile communication device, such as a wireless phone. Further, the interaction may be performed in a variety of ways, such as a specially configured application 304, via a browser, and so on to specify values to be used in the loyalty offer 208, e.g., via a template 308. Thus, the merchant 202 may model a variety of different loyalty offers using a variety of different techniques.

Information is transmitted via the network for receipt by the loyalty service, at least a portion of the information describing consumer interaction with the merchant that pertains to the loyalty offer that is sufficient for use by the loyalty service to manage participation of the consumers with the one or more loyalty offers of the merchant (block 404). The merchant, for instance, may collect transaction data and data that describes loyalty offers. This data may be communicated to the loyalty service 204 for processing such that the loyalty service 204 may manage participation by consumers with the loyalty offers 208 of the merchant.

The identifiers used by the loyalty service 204 to determine which consumers participated with which offers may be configured in a variety of ways. For example, each consumer may be provided with a unique loyalty offer 208 identifier such that both the loyalty offer 208 and the consumer may be identified from a single identifier. In another example, loyalty offer 208 identifiers may be combined with an identifier of the consumer to manage participation. A variety of other examples are also contemplated.

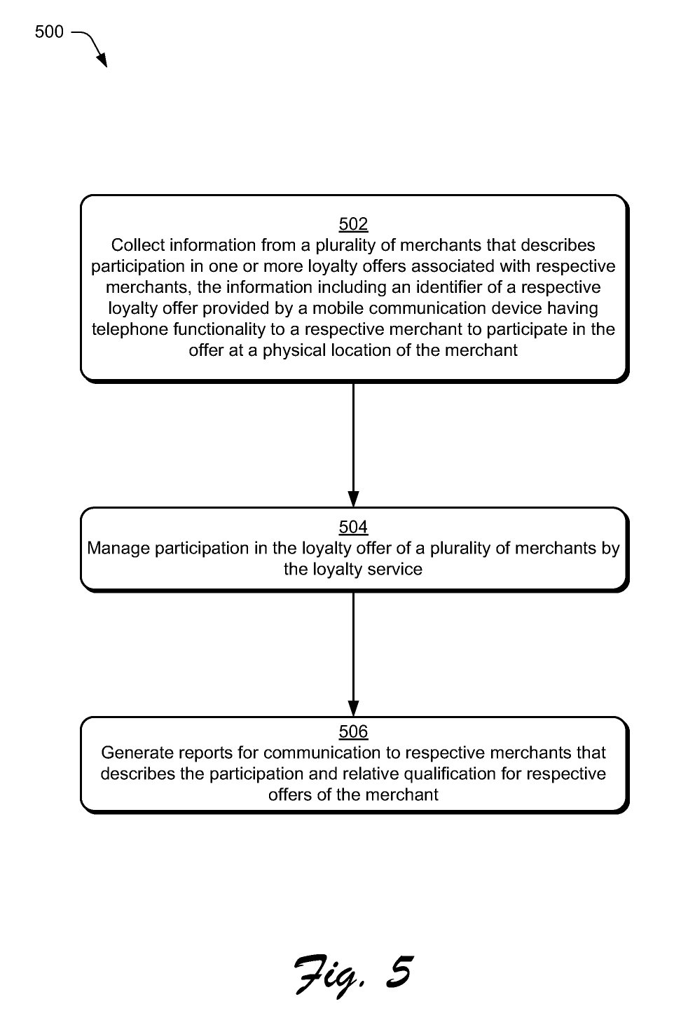

FIG. 5 depicts a procedure 500 in an example implementation in which information is collected by a loyalty service to manage participation in loyalty offers for a plurality of merchants. Information is collected from a plurality of merchants that describes participation in one or more loyalty offers associated with respective merchants, the information including an identifier of a respective loyalty offer provided by a mobile communication device having telephone functionality to a respective merchant to participate in the offer at a physical location of the merchant (block 502). A consumer, for instance, may take a mobile phone to a physical location of merchant and use the mobile phone to purchase goods or services using the techniques described in relation to FIG. 1. The mobile phone may also provide credentials that may be used to participate in a loyalty offer 208. These credentials may be provided automatically as part of the transaction, provided manually through selection in a user interface, and so on. The merchant may then transmit this information over the network 108 to the loyalty service 204

Participation in the loyalty offer of a plurality of merchants is managed by the loyalty service (block 504). The loyalty service 204, for instance, may act as a centralized clearinghouse to manage loyalty offers of a plurality of merchants. In this way, the merchants may “offload” this management to the service without having to providing this functionality themselves. Indeed, merchants may even avail themselves to this functionality with a mobile communication device themselves to model loyalty offers 208 and provide information to the loyalty service 204 regarding participation in the loyalty service.

The loyalty service may then generate reports for communication to respective merchants that describes the participation and relative qualification for respective offers of the merchant (block 506). The reports 222, for instance, may describe that a particular consumer has performed a certain amount of eligible purchases, overall participation by consumers, related transactions that do not pertain directly to the loyalty offer, and so on. This information may also be provided to the consumers themselves in the form of reports. Thus, the loyalty service 204 may implement a variety of different techniques to support modeling and management of loyalty offers 208.

Example Device

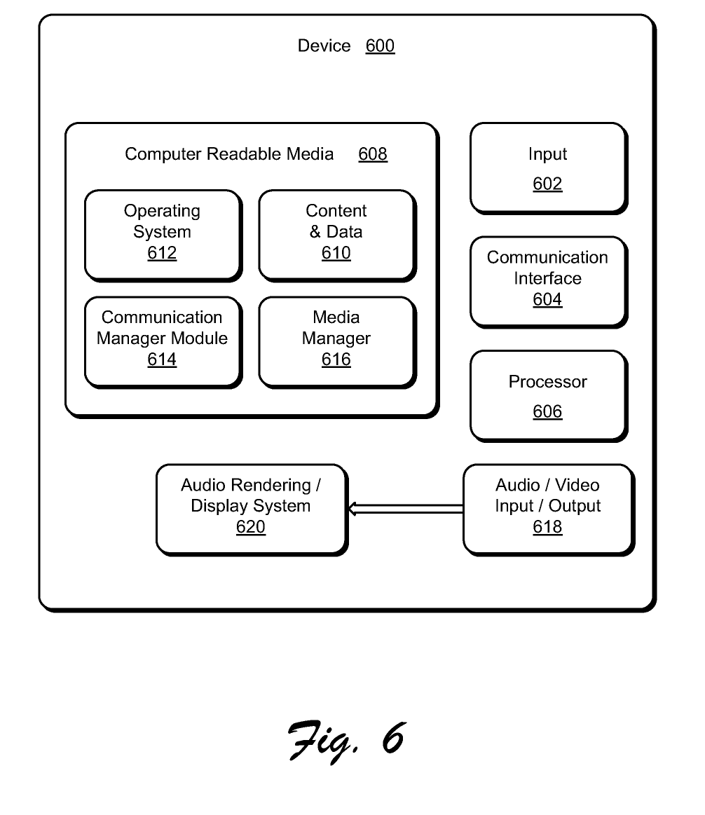

FIG. 6 illustrates various components of an example device 600 that can be implemented in various embodiments as any type of a mobile device to implement embodiments of devices, features, and systems for mobile communications. For example, device 600 can be implemented as any of the mobile communications devices 104 described previously. Device 600 can also be implemented to access a network-based service, such as a social network service as previously described.

Device 600 includes input 602 that may include Internet Protocol (IP) inputs as well as other input devices, such as the keyboard 112 of FIG. 1. Device 600 further includes communication interface 604 that can be implemented as any one or more of a wireless interface, any type of network interface, and as any other type of communication interface. A network interface provides a connection between device 600 and a communication network by which other electronic and computing devices can communicate data with device 600. A wireless interface enables device 600 to operate as a mobile device for wireless communications.

Device 600 also includes one or more processors 606 (e.g., any of microprocessors, controllers, and the like) which process various computer-executable instructions to control the operation of device 600 and to communicate with other electronic devices. Device 600 can be implemented with computer-readable media 608, such as one or more memory components, examples of which include random access memory (RAM) and non-volatile memory (e.g., any one or more of a read-only memory (ROM), flash memory, EPROM, EEPROM, etc.).

Computer-readable media 608 provides data storage to store content and data 610, as well as device applications and any other types of information and/or data related to operational aspects of device 600. For example, an operating system 612 can be maintained as a computer application with the computer-readable media 608 and executed on processor 606. Device applications can also include a communication manager module 614 (which may be used to provide telephonic functionality) and a media manager 616.

Device 600 also includes an audio and/or video output 618 that provides audio and/or video data to an audio rendering and/or display system 620. The audio rendering and/or display system 620 can be implemented as integrated component(s) of the example device 600, and can include any components that process, display, and/or otherwise render audio, video, and image data. Device 600 can also be implemented to provide a user tactile feedback, such as vibrate and haptics.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computing device, the method comprising:
interacting with a loyalty service via a network to model one or more loyalty offers for a use in conjunction with a merchant; and
transmitting information via the network for receipt by the loyalty service, at least a portion of the information describing consumer interaction with the merchant that pertains to the loyalty offer and is sufficient for use by the loyalty service to manage participation of the consumers with the one or more loyalty offers of the merchant.

2. A method as described in claim 1, wherein the interaction involves interacting with a template provided by the loyalty service to model the one or more loyalty offers.

3. A method as described in claim 1, wherein the interacting is performed through local execution of an application by the computing device.

4. A method as described in claim 3, wherein the application is downloaded to the computing device via an Internet from an application marketplace.

5. A method as described in claim 3, wherein the application is a browser.

6. A method as described in claim 1, wherein the information also includes an identifier of the loyalty offer and an identifier of a mobile communication device that was used to communicate the identifier of the loyalty offer to the merchant.

7. A method as described in claim 1, wherein the interacting and the transmitting are performed by the merchant.

8. A method as described in claim 1, wherein the loyalty service is configured to manage participation of consumers with loyalty offers obtained from a plurality of different merchants.

9. A method as described in claim 1, wherein the loyalty service is configured to communicate data to mobile communication devices of respective said consumers that describes the consumer's participation in at least one of the loyalty offers.

10. A method as described in claim 1, wherein the interacting and the transmitting are performed by a mobile communication device having telephone functionality.

11. A method as described in claim 1, wherein the computing device is configured to provide information to mobile communication devices of the consumers of the merchant to cause the mobile communication device to automatically provide identifiers usable to participate with at least one of the loyalty offers.

12. A method as described in claim 1, wherein at least a portion of the information is provided to a merchant that performs the transmitting by a mobile communication device of a respective said consumer, the at least the portion of the information provisioned on a secure element of the mobile communication device using a private key to decrypt the information without exposing the information or the private key outside of the secure element.

13. A method implemented by one or more servers of a loyalty service, the method comprising:
collecting information from a plurality of merchants that describes participation in one or more loyalty offers associated with respective merchants, the information including an identifier of a respective said loyalty offer provided by a mobile communication device having telephone functionality to a respective said merchant to participate in the offer at a physical location of the merchant; and
generating reports for communication to respective said merchants that describe the participation and relative qualification for respective said offers of the merchant.

14. A method as described in claim 13, wherein the information describes transactions for goods or services initiated at physical locations of respective said merchants and includes identifiers that uniquely identify mobile communication devices that were used to initiate the transactions.

15. A method as described in claim 13, wherein at least a portion of the information is obtained by employing a secure element of the mobile communication device implemented in tamper-resistant hardware.

16. A method as described in claim 13, wherein the report describes other purchases made by a respective said consumer that do not qualify for the one or more loyalty offers.

17. A mobile communication device comprising:
a processor;
hardware configured to implement telephone communication;
tamper-resistant hardware implementing a secure element as storing:
purchase credentials usable to initiate a purchase of a good or service; and
loyalty offer credentials usable to participate in a loyalty offer of a respective one of a plurality of merchants; and
memory having instructions stored therein, the instructions being executable by the processor to cause the mobile communication device to search the loyalty offer credentials stored in the secure element.

18. A mobile communication device of claim 17, wherein the search is based on least in part on a current geographic location of the mobile communication device.

19. A mobile communication device of claim 17, wherein the search is based on least in part on identification of a particular merchant with which the mobile communication device is interacting to purchase the good or service using the purchase credentials in the secure element and the search is performed automatically and without user intervention responsive to the identification of the particular merchant.

20. A mobile communication device of claim 17, wherein the search is based on least in part on identification of a particular merchant with which the mobile communication device and is performed automatically and without user intervention responsive to identification of a particular merchant and causes output of data in a user interface on a display device of the mobile communication device that describes one or more of the loyalty offers that correspond to the particular merchant.
